(19) United States
(12) Patent Application Publication
(10) Pub. No.: US 2025/0129598 A1
(43) Pub. Date: Apr. 24, 2025

(54) Long-Term Insulation Wall-Sheathing And Weather-Resistant Barrier System

(71) Applicant: Henry Company, LLC, Kimberton, PA (US)

(72) Inventors: Divya Chopra, West Chester, PA (US); Bradley Clark, Quakertown, PA (US)

(21) Appl. No.: 18/882,015

(22) Filed: Sep. 11, 2024

Related U.S. Application Data
(60) Provisional application No. 63/581,736, filed on Sep. 11, 2023.

(51) Int. Cl. E04B 1/76; B32B 7/12; B32B 21/02; B32B 21/04; B32B 21/06; E04B 1/62

(52) U.S. Cl. CPC E04B 1/7675; B32B 7/12; B32B 21/02; B32B 21/047; B32B 21/06; E04B 1/625; B32B 2250/04; B32B 2260/028; B32B 2260/046; B32B 2266/0228; B32B 2266/0278; B32B 2266/06; B32B 2307/304; B32B 2307/718; B32B 2307/72; B32B 2307/724; B32B 2307/7265; B32B 2419/00

(57) ABSTRACT

This invention relates to insulated wall-sheathing (IWS) panels, a panel assembly comprising such panels, and systems for use in building construction designed to provide moisture permeable panels that protect from bulk water, excess air, and thermal transfer. More specifically, this invention relates such panel used for construction purposes, comprising multiple insulation layers including an open-celled foam layer; a structurally-stable panel; an optional nail-gasketing adhesive layer; and a weather-resistive barrier layer; wherein, optionally, the weather-resistive barrier (WRB) layer exceeds the dimension of the wood-composite panel from at least one of its edges to create an extension flap; and wherein the extension flap of the WRB layer further comprises a removably attached release-liner on its back. This invention allows for a longevity of the wall due to the improvement in permeation characteristics from the presence of the open-celled foam insulation layer.

### CROSS-REFERENCE TO RELATED APPLICATIONS

This application claims priority to and the benefit of U.S. Provisional Patent Application No. 63/581,736 (filed Sep. 11, 2023) which is incorporated by reference herein in its entirety for any and all purposes.

### FIELD OF INVENTION

This invention relates to insulated wall-sheathing (IWS) panels, a panel assembly comprising such panels, and systems for use in building construction designed to provide moisture permeable panels that protect from bulk water, excess air, and thermal transfer. More specifically, this invention relates such panel used for construction purposes, comprising multiple insulation layers including an open-celled foam layer; a structurally-stable panel; an optional nail-gasketing adhesive layer; and a weather-resistive barrier layer; wherein, optionally, the weather-resistive barrier (WRB) layer exceeds the dimension of the wood-composite panel from at least one of its edges to create an extension flap; and wherein the extension flap of the WRB layer further comprises a removably attached release-liner on its back. This invention allows for a longevity of the wall due to the improvement in permeation characteristics from the presence of the open-celled foam insulation layer.

### BACKGROUND

Wall panel construction systems of residential or commercial buildings do not typically provide simple, efficient, and safe means of installation. Most often in these systems, extra steps must typically be added to the installation process to prevent liquid moisture, air, and heat from passing through the wall.

Constructing a wall with a weather barrier requires not only that panels be attached to framing members, but also a house-wrap is unrolled and spread over the walls. The house-wrap is attached to the sheathing panels with staples or button cap nails and fenestration openings for windows or doors must be cut out of the wrap and the flaps from these openings folded back and stapled down. The house-wrap is often difficult to install because it is in typical nine-ft wide rolls, which can be cumbersome to maneuver by workers on scaffolding or in windy conditions. While it is important that the barrier layer shed bulk water, it should allow for the escape of water vapor. Moreover, since house-wraps are only fastened at limited points, pockets or voids form between the sheathing and house wrap. If the barrier were to trap water vapor in a wall panel, the build-up of moisture could lead to rot or mold growth. Further, certain sheathing materials, such as oriented strand board (OSB), are known to irreversibly swell and warp when exposed to moisture.

Furthermore, small gaps along the edges of adjoining panels typically remain after installation assembly. These thermal gaps within the building envelope allow undesirable thermal energy entry and escape through the walls. Although house wrap can provide some protection, breaks or tears in the house wrap often form during installation or construction. Foam insulation sheathing has also been used to improve thermal resistance performance of building structures. However, insulation sheathing also presents certain limitations and challenges. In addition to frequently suffering physical damage during installation and construction, the structural properties of insulation sheathing relegates it to limited building applications. Insulation wall-sheathing panels are typically fastened as exterior cladding to the outermost, exterior facing of the wall with nails, screws, or staples. Once again, this is an extra step that must be added to the installation process. Moreover, as an additional fastened layer, pockets or voids inevitably form between it and the surface it is secured to. Moreover, most insulation sheathing can also limit external finishing options.

It is desirable for wall sheathing panels to shed precipitation, such as rain and snow, during construction so that the interior remains dry. Accordingly, there is a need in the art for wall-sheathing panels, which are resistant to bulk water but permeable to water vapor, provide improved thermal resistance and create a simplified, safe, and time-saving installation process.

Given the foregoing, there is a continuing need to develop improved panels for wall construction that prevent or minimize the penetration of bulk water, which come pre-equipped with a water permeable barrier layer applied during manufacture, and that have improved thermal performance.

### SUMMARY OF THE INVENTION

In one embodiment, this invention relates to a first IWS panel used for construction purposes, comprising the following layers: an optional insulation facer layer having an outer surface and an inner surface; a first open-celled insulation layer having an outer surface and an inner surface; wherein, when the insulation facer layer is present, the inner surface of the insulation facer is planarly and contactably attached to the outer surface of the first open-celled insulation layer a first insulation layer having an outer surface and an inner surface; wherein the inner surface of the first open-celled insulation layer is planarly and contactably attached to the outer surface of the first insulation layer; a first structurally stable panel having an outer surface and an inner surface, and at least one edge extending between its outer surface and the inner surface; wherein the inner surface of the first insulation layer is planarly and contactably attached to the outer surface of the first structurally stable panel; and a first WRB layer having an outer surface and an inner surface, wherein the inner surface of the WRB layer is secured to the outer surface of the first structurally stable panel through an adhesive layer, or through a fastener-gasketing layer, or through an adhesive layer and a fastener-gasketing layer; wherein, optionally, the WRB layer exceeds the dimension of the first structurally stable panel from at least one of its edges to create an extension flap; and wherein the extension flap of the WRB layer further comprises a removably attached release-liner attached to the WRB layer's inner surface.

In one embodiment, this invention relates to the IWS panel as recited above, wherein the structurally stable panel is a wood-composite panel.

In one embodiment, this invention relates to the IWS panel as recited above, wherein the wood-composite panel is a lignocellulosic panel.

In one embodiment, this invention relates to the IWS panel as recited above, wherein the lignocellulosic panel is an OSB panel.

In one embodiment, this invention relates to the IWS panel as recited above, wherein the open-celled insulation layer is a spray foam or EPS.

In one embodiment, this invention relates to the IWS panel as recited above, wherein the open-celled insulation layer is a spray foam or EPS, and wherein the blowing is in an aqueous medium.

In one embodiment, this invention relates to the IWS panel as recited above, wherein the WRB layer is substantially bulk water resistant and substantially water vapor permeable.

In one embodiment, this invention relates to the IWS panel as recited above, wherein the extension flap is continuous or discontinuous along the length of the edge from which it exceeds beyond the panel.

In one embodiment, this invention relates to the IWS panel as recited above, wherein the extension flap, in the direction perpendicular to the edge of the lignocellulosic panel, is 0.1% to 50% of the shortest and the longest dimension of the lignocellulosic panel, respectively.

In one embodiment, this invention relates to the IWS panel as recited above, wherein the extension flap in its direction parallel to the edge of the lignocellulosic panel, is from 0% to 20% the length of the edge of the panel.

In one embodiment, this invention relates to the IWS panel as recited above, wherein the release liner covers the surface area of the extension flap of the barrier layer from about 10% to 100%.

In one embodiment, this invention relates to the IWS panel as recited above, wherein the first insulation layer is foam insulation comprising polyisocyanurate foam, polystyrene foam, polyurethane foam, EPS, GPS, XPS, or a combination thereof.

In one embodiment, this invention relates to the IWS panel as recited above, wherein the first insulation layer has a density in the range of about 1 to about 20 pounds per cubic feet (pcf) according to ASTM D1622.

In one embodiment, this invention relates to the IWS panel as recited above, wherein the first insulation layer has a water absorption of less than about 10% according to ASTM C209 or ASTM C2842.

In one embodiment, this invention relates to the IWS panel as recited above, wherein the first insulation layer has a water vapor permeance from about 0.1 to about 20 perms as determined according to ASTM E96.

In one embodiment, this invention relates to the IWS panel as recited above, wherein the system exhibits a thermal resistance value (R-value) from about 1 to about 15 according to ASTM C1289-02.

In one embodiment, this invention relates to the IWS panel as recited above, wherein the first open-celled insulation layer further comprises a membrane layer.

In one embodiment, this invention relates to the IWS panel as recited above, wherein the insulation membrane layer comprises radiant barrier material, polymeric film, polymeric fabric, paper, cellulosic material, reinforcing scrim, or a combination thereof.

In one embodiment, this invention relates to the IWS panel as recited above, wherein the first insulation layer is secured to the panel using an adhesive selected from a phenol-formaldehyde resin, hot-melt adhesive, polyvinyl acetate (PVA) resin, or a combination thereof.

In one embodiment, this invention relates to the IWS panel as recited above, wherein the WRB barrier layer comprises a resin-impregnated paper substantially covering the outward facing surface of the panel, the resin-impregnated paper having a paper basis weight of 21.772 kg (48 lbs.) to about 102.058 kg (225 lbs.) per ream and a resin content of less than 80% by dry weight.

In one embodiment, this invention relates to the IWS panel as recited above, wherein each panel and barrier layer has a water vapor transmission rate from about 0.7 to about 7 grams/m²/24 hrs as determined according to ASTM E96 procedure A (at 73° F.-50% RH) and a liquid water transmission rate from about 1 to about 28 grams/100 in²/24 hrs via Cobb ring according to ASTM D5795.

In one embodiment, this invention relates to the IWS panel as recited above, wherein an outer surface of the barrier layer is textured.

In one embodiment, this invention relates to the IWS panel as recited above, wherein the textured outer surface provides a wet coefficient of friction in a range of about 0.8 to about 1.1 (English XL Tribometer) and a dry coefficient of friction of at least about 0.8 (English XL Tribometer).

In one embodiment, this invention relates to the IWS panel as recited above, wherein each panel comprises an oriented strand board, a plywood, a particleboard, a chipboard, a medium-density fiberboard, or a waferboard.

In one embodiment, this invention relates to the IWS panel as recited above, wherein the structurally stable panel comprises other plant-based materials, said other plant-based materials are described as below:

grass, including perennial grass, switchgrass such as Panicum virgatum L, Miscanthus, Sorghum, sugarcane, millets, Napier grass, giant reed, and other forage and turf grasses, subalpine grasses, native grass, sedge, rush include Agrostis exarata (Spike Bentgrass), Ammophila arenaria (European sand dune or beach grass), Ammophila breviligulata (American beach grass), Ammophila champlainensis Seymour, Ammophila maritima, Beckmannia zyzigachne (American Sloughgrass), Bromus carinatus (California Brome), Bromus vulgaris (Columbia Brome), Carex densa (Dense-Headed Sedge), Carex feta (Green-Sheathed Sedge), Carex leporina (Harefoot Sedge), Carex lenticularis (=C. kelloggii) (Shore Sedge), Carex lyngbyel (Lyngby Sedge), Carex macrocephala (Big Headed Sedge), Carex obnupta (Slough Sedge), Carex pansa (Foredune Sedge), Carex unilateralis (One-Sided Sedge), Deschampsia caespitosa (Tufted Hair Grass), Eleocharis palustis (Creeping Spike rush), Elymus glaucus (Blue Wild Rye), Festuca idahoensis var. roemeri (Roemer's Fescue), Festuca rubra var. littoralis (Shore Fescue), Festuca subulata (Bearded Fescue), Glyceria elata (Tall Mannagrass), Glyceriaoccidentalis (Western Mannagrass), Hordeum brachyantherum (Meadow Barley), Juncus effusus (Soft Rush), Juncus patens (Spreading Rush), Juncus tenuis (Slender Rush), Lozula campestris (Woodrush), Phalaris arundinacea (Reed Canary Grass), Phalaris aquatica, Phalaris tuberosa (Staggers Grass), Phalaris canariensis, Poa Macrantha (Dune Bluegrass), ReGreen (Sterile Hybrid Wheat), Scirpus acutus (Hardstem Bullrush), Scirpus americanus, Scirpus cyperinus, Scirpus maritimus (Seacoast Bullrush), Scirpus microcarpus, Scirpus validus, Sparaganuim eurycarpum (Giant Burreed), Triglochin maritinum (Seaside Arrowgrass), Typha latifolia (Cattail), Alopecuris geniculatus, Carex pachystachya, Carex stipata (grass like), Danthonia californica, Eleocharis ovata (grass like), Glycaria grandis, Juncus acuminatus, Juncus bolanderi and Juncus ensifolius (Daggar leaf rush). By way of example, other grasses include the Lily of the Nile (Agapanthus africanus), white fountain grass (Pennisetum ruppellii), muhly grass (Muhlenbergia capillaris), African iris (Dietes vegeta), podocarpus (Podocarpus macrophyllus), wax myrtle (Myrica cerifera), Aztec grass (Ophiopogon intermedius argenteomarginatus), mondo grass (Ophiopogon japonicus), evergreen giant (Liriope muscan), evergreen Paspalum (Paspalum quadrifarium) and sand cord grass (Spartina bakerii).

In one embodiment, this invention relates to the IWS panel as recited above, wherein the structurally stable panel comprises other plant-based materials, said other plant-based materials comprising flax fibers and flax shives produced from processing waste flax straw.

In one embodiment, this invention relates to the IWS panel as recited above, wherein the lignocellulosic component in the wood-composite panel includes more than one of the plant-based materials.

In one embodiment, this invention relates to the IWS panel as recited above, wherein the wood composite panel comprises a binder material and other plant-based material, wherein said panel includes at least 70 percent other plant-based material by weight and at least 2.5 percent thermoplastic binder by weight.

In one embodiment, this invention relates to the IWS panel as recited above, wherein said thermoplastic binder material comprises high density polyethylene.

In one embodiment, this invention relates to the IWS panel as recited above, wherein said thermoplastic binder material comprises recycled high-density polyethylene.

In one embodiment, this invention relates to the IWS panel as recited above, wherein said binder material is a formaldehyde-free binder.

In one embodiment, this invention relates to the IWS panel as recited above, wherein said binder material contains zero volatile organic compounds (VOC).

In one embodiment, this invention relates to the IWS panel as recited above, wherein said binder material comprises polymeric methylene diphenyl diisocyanate (PMDI).

In one embodiment, this invention relates to the IWS panel as recited above, wherein said binder material comprises a protein-based resin.

In one embodiment, this invention relates to the IWS panel as recited above, wherein said protein-based resin is selected from the group of protein-based resins consisting of a soy protein-based resin, a canola protein-based resin, a castor protein-based resin, jatropha protein-based resin and combinations thereof.

In one embodiment, this invention relates to the IWS panel as recited above, wherein said panel includes 80 to 90 percent other plant-based material portions by weight, 8 to 12 percent recycled high density polyethylene and 3 to 5 percent polymeric methylene diphenyl diisocyanate (PMDI) by weight.

In one embodiment, this invention relates to the IWS panel as recited above, wherein said panel comprises at least two oriented strand layers, each oriented strand layer containing a binder material and other plant-based material portions, each oriented strand layer having a layer axis with greater than 90% of said other plant-based material portions aligned within +/−45 degrees of said layer axis, and wherein at least one oriented strand layer has a layer axis oriented at a non-zero angle relative to a layer axis of another oriented strand layer.

In one embodiment, this invention relates to the IWS panel as recited above, wherein said structurally stable panel is selected from the group of wood composite panel types consisting of oriented strand wood composite panel, fiber wood composite panel, particle wood composite panel and layer comprising other plant-based material.

In one embodiment, this invention relates to the IWS panel as recited above, wherein said panel has a density in the range of 42 to 54 lbs/ft³.

In one embodiment, this invention relates to the IWS panel or panel assembly as recited above, wherein the open-celled foam layer comprises a sprayable foam that is made from polyurethane sprayable foams, polyurea sprayable foams, and combinations thereof.

In one embodiment, this invention relates to the IWS panel or panel assembly as recited above, wherein the sprayable foam is selected from the group consisting of acrylic foams, latex foams, melamine foams, isocyanurate foams, and silicone foams.

In one embodiment, this invention relates to the IWS panel or panel assembly as recited above, wherein the open-celled polyurethane with the open cell structure has a density of between 0.60 and 1.5 lb. per cubic foot, or the density of the open cell polyurethane foam is between 0.90 and 1.20 lb. per cubic foot, or the density of the foamed open cell polyurethane foam is between 1.00 and 1.15 lb. per cubic foot.

In one embodiment, this invention relates to the IWS panel or panel assembly as recited above, wherein the open cell content of the foams of the first open-celled foam insulation layer of the present invention, in one embodiment is greater than 85%, or 90%, or 95%, or 98%.

In one embodiment, this invention relates to the IWS panel or panel assembly as recited above, wherein the blowing agent is, water, carbon dioxide, hydrofluorocarbons (HFCs), chlorinated fluorocarbons, or hydrofluoro olefins (HFOs).

In one embodiment, this invention relates to a panel assembly comprising at least two panels juxtaposed and/or adhered to each other, wherein at least one panel is according to the IWS panel, as recited above.

In one embodiment, this invention relates to a method of manufacturing an IWS panel or an IWS panel system, wherein the wood composite panel is made by a method comprising the steps of: combining a binder material and other plant-based material portions to produce a combined material, wherein said combined material includes at least 70 percent other plant-based material portions by weight and at least 2.5 percent thermoplastic binder by weight; and heating and pressing said combined material.

In one embodiment, this invention relates to a method as recited above, wherein the heating and pressing step is accomplished in a press at a temperature in the range of 125 to 400 degrees Fahrenheit.

In one embodiment, this invention relates to a method as recited above, wherein the heating and pressing step is accomplished in a press at a pressure in the range of 100 to 300 psi.

In one embodiment, this invention relates to a method as recited above, wherein said other plant-based material portions have a moisture content in the range of about 1.0 to 5.0 percent when combined with the binder.

In one embodiment, this invention relates to a method as recited above, further comprising the steps of: harvesting other plant materials by mowing other plant-based materials; conditioning each mowed stalk at the harvest site by crimping the mowed stalk at a plurality of locations to increase other plant-based material drying; refining other plant-based material into fibers using a mill; screening the fibers to remove other plant-based material fines.

In one embodiment, this invention relates to a wood composite panel made by a process comprising the steps of: combining a binder material and other plant-based material portions to produce a combined material, wherein said combined material includes at least 70 percent other plant-based material portions by weight and at least 2.5 percent thermoplastic binder by weight; and heating and pressing said combined material.

### BRIEF DESCRIPTION OF THE DRAWINGS

FIG. 1 shows a schematic of a concept for the IWS panel comprising a structurally stable panel adjacent the insulation layer with an adhesive but not a fastener-gasketing adhesive.

FIG. 2 depicts a schematic of a concept for the IWS panel comprising a fastener-gasketing adhesive.

FIG. 3 depicts a schematic of a concept for the IWS panel comprising an adhesive and a fastener-gasketing adhesive.

FIG. 4 depicts a schematic of a concept for the IWS panel in its front view comprising extension flaps with a release liner on the back with various shapes and contours of the extension flaps.

FIG. 5 shows a schematic of the concept for placing multiple IWS panels with extension flaps juxtaposed with each other where the extension flaps perform the scaling function of the gaps between the panels.

FIG. 6 shows a schematic of the concept shown in FIG. 3, in which an insulation facer is placed on the insulation layer.

### DETAILED DESCRIPTION OF THE INVENTION

Before the present compositions, articles, devices, and/or methods are disclosed and described, it is to be understood that the aspects described below are not limited to specific methods as such may, of course, vary. It is also to be understood that the terminology used herein is for the purpose of describing particular aspects only and is not intended to be limiting. As used in the specification and in the claims, the term “comprising” may include the embodiments “consisting of” and “consisting essentially of.”

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, and the like of these materials are disclosed that while specific reference of each various individual and collective combinations and permutation of these compounds cannot be explicitly disclosed, each is specifically contemplated and described herein. Thus, if a class of adhesives A, B, and C are disclosed as well as a class of additives D, E, and F and an example of a combination A-D is disclosed, then even if cach is not individually recited, cach is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. This concept applies to all aspects of this disclosure including, but not limited to, compositions, and steps in methods of making and using the disclosed compositions. Thus, if there are a variety of additional steps that can be performed it is understood that each of these additional steps can be performed with any specific embodiment or combination of embodiments of the disclosed methods, and that cach such combination is specifically contemplated and should be considered disclosed.

Unless expressly stated otherwise, it is not intended that any method outlined herein be construed as requiring that its steps be performed in a particular order. Accordingly, where a method claim does not expressly recite an order to be followed by its steps, or where neither the claims nor the descriptions specifically state that the steps are to be limited to a precise sequence, it should not be inferred that a specific order is intended or required. This holds for any possible non-express basis for interpretation, including, but not limited to: logical flow or arrangement of steps; interpretations derived from the grammatical organization, syntax, or punctuation; and the quantity or variety of embodiments detailed in the specification. The description of the invention should not be read as mandating a fixed sequence of steps, unless such a requirement is articulated explicitly.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, a., are by weight. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an endpoint of a range, the disclosure should be understood to include the specific value or endpoint referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise. As used in the specification and the appended claims, the singular forms “a,” “an,” and “the” include plural referents unless the context clearly dictates otherwise.

The term “predominant portion” or “predominantly”, as used herein, unless otherwise defined herein, means greater than 50% of the referenced material. If not specified, the percent is on a molar basis when reference is made to a molecule (such as hydrogen and ethylene), and otherwise is on a weight basis (such as for additive content).

The term “substantial portion” or “substantially”, as used herein, unless otherwise defined, means all or almost all or the vast majority, as would be understood by the person of ordinary skill in the context used. It is intended to take into account some reasonable variance from 100% that would ordinarily occur in industrial-scale or commercial-scale situations.

All parts, percentages and ratios used herein are expressed by weight unless otherwise specified.

In this specification and in the claims which follow, reference will be made to a number of terms which shall be defined herein.

“Optional” or “optionally” means that the subsequently described event or circumstance can or cannot occur, and that the description includes instances where the event or circumstance occurs and instances where it does not.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification. Throughout this application, various publications are referenced. The disclosures of these publications in their entireties are hereby incorporated by reference into this application in order to more fully describe the state of the art to which they pertain. The references disclosed are also individually and specifically incorporated by reference herein for the material contained in them that is discussed in the sentence in which the reference is relied upon. Nothing herein is to be construed as an admission that the present invention is not entitled to antedate such publication by virtue of prior invention. Further, the dates of publication provided herein may be different from the actual publication dates, which can require independent confirmation. In the context of the present description, all publications, patent applications, patents and other references mentioned herein, if not otherwise indicated, are explicitly incorporated by reference herein in their entirety for all purposes as if fully set forth.

The following describes exemplary embodiments of the present invention in the building construction context, which pertains to insulated wall-sheathing (IWS) panels for a panelized sheathing assembly and system attached to a frame structure of the building, and that are suitable for use in the construction of residential and commercial buildings.

### I. Illustrative Embodiments

### Embodiment 1

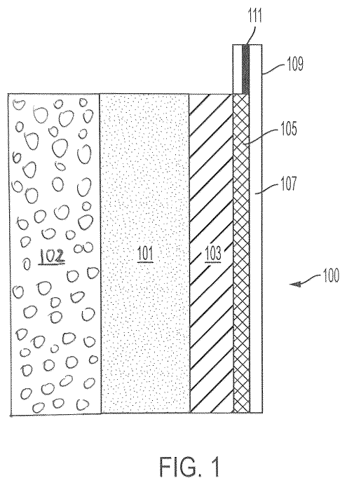

As shown in FIG. 1, in one embodiment, the present invention relates to a first IWS panel (100) used for construction purposes, comprising the following layers: a first open-celled insulation layer (102) having an outer surface and an inner surface; an insulation layer (101) having an outer surface and an inner surface; a first structurally-stable panel (103) having an outer surface and an inner surface, and at least one edge extending between its outer surface and the inner surface; wherein the inner surface of the first open-celled insulation layer (102) is planarly and contactably attached to the outer surface of the first insulation layer (101); wherein the inner surface of the first insulation layer (101) is planarly and contactably attached to the outer surface of the first structurally-stable panel; and a first WRB layer (107) having an outer surface and an inner surface, wherein the inner surface of the WRB layer is secured to the outer surface of the first structurally-stable panel through an adhesive layer (105); wherein, optionally, the WRB layer (107) exceeds the dimension of the first structurally-stable panel (103) from at least one of its edges to create an extension flap (109); and wherein the extension flap (109) of the WRB layer further comprises a removably attached release-liner (111) attached to the WRB layer's inner surface.

### Embodiment 2

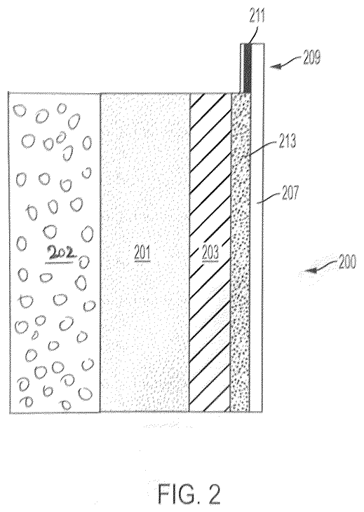

As shown in FIG. 2, in one embodiment, the present invention relates to a first IWS panel (200) used for construction purposes, comprising the following layers: a first open-celled insulation layer (202) having an outer surface and an inner surface; an insulation layer (201) having an outer surface and an inner surface; a first structurally-stable panel (203) having an outer surface and an inner surface, and at least one edge extending between its outer surface and the inner surface; wherein the inner surface of the first open-celled insulation layer (202) is planarly and contactably attached to the outer surface of the first insulation layer (201); wherein the inner surface of the first insulation layer (201) is planarly and contactably attached to the outer surface of the first structurally-stable panel (203); and a first WRB layer (207) having an outer surface and an inner surface, wherein the inner surface of the WRB layer is planarly and contactably attached to the outer surface of the first structurally-stable (203) panel through a fastener-gasketing layer (213); wherein optionally, the WRB layer (207) exceeds the dimension of the first structurally-stable panel (203) from at least one of its edges to create an extension flap (209); and wherein the extension flap (209) of the WRB layer further comprises a removably attached release-liner (211) attached to the WRB layer's inner surface.

### Embodiment 3

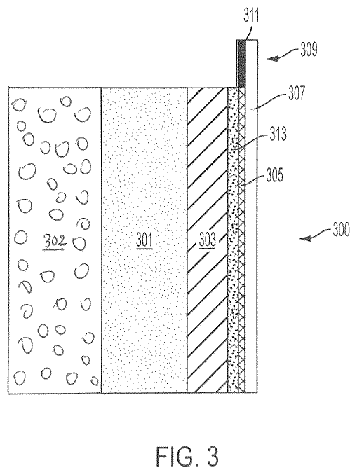

As shown in FIG. 3, in one embodiment, the present invention relates to a first IWS panel (300) used for construction purposes, comprising the following layers: a first open-celled insulation layer (302) having an outer surface and an inner surface; an insulation layer (301) having an outer surface and an inner surface; a first structurally-stable panel (303) having an outer surface and an inner surface, and at least one edge extending between its outer surface and the inner surface; wherein the inner surface of the first open-celled insulation layer (302) is planarly and contactably attached to the outer surface of the first insulation layer (301); wherein the inner surface of the first insulation layer (301) is planarly and contactably attached to the outer surface of the first structurally-stable panel (303); and a first WRB layer (307) having an outer surface and an inner surface, wherein the inner surface of the WRB layer is planarly and contactably attached to the outer surface of the fastener-gasketing layer (313) and the fastener-gasketing layer (313) is planarly and contactably attached to the first structurally-stable (303) panel through an adhesive layer (305); wherein the WRB layer (307) exceeds the dimension of the first structurally-stable panel (303) from at least one of its edges to create an extension flap (309); and wherein the extension flap (309) of the WRB layer further comprises a removably-attached release-liner (311) attached to the WRB layer's inner surface.

### Embodiment 4

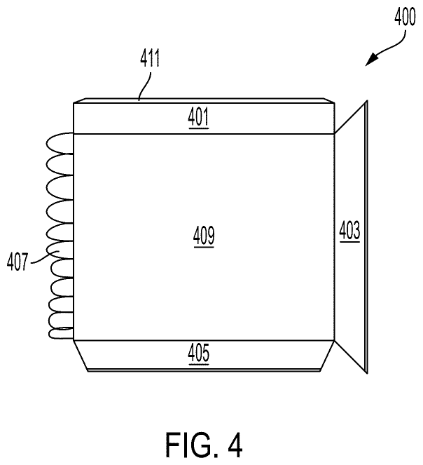

FIG. 4 depicts a schematic of a concept for the IWS panel in its front view comprising extension flaps with a release liner on the back with various shapes and contours of the extension flaps. In one embodiment, the extension flap has various shapes and sizes, as described infra in the section on the WRB layer.

In another embodiment, the IWS panel does not comprise an extension flap and the release line.

### Embodiment 5

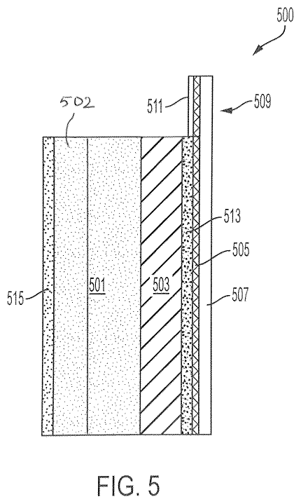

As shown in FIG. 5, in one embodiment, the present invention relates to a first IWS panel (500) used for construction purposes, comprising the following layers:

An insulation facer layer (515) having an outer surface and an inner surface; a first open-celled insulation layer (502) having an outer surface and an inner surface; wherein the inner surface of the insulation facer (515) is planarly and contactably attached to the outer surface of the open-celled insulation layer (502); a first insulation layer (501) having an outer surface and an inner surface; wherein the inner surface of the open-celled insulation layer (502) is planarly and contactably attached to the outer surface of the first insulation layer (501); a first structurally stable panel (503) having an outer surface and an inner surface, and at least one edge extending between its outer surface and the inner surface; wherein the inner surface of the first insulation layer (501) is planarly and contactably attached to the outer surface of the first structurally-stable panel (503); and a first WRB layer (507) having an outer surface and an inner surface, wherein the inner surface of the WRB layer is planarly and contactably attached to the outer surface of an optional fastener-gasketing layer (513) and the fastener-gasketing layer (513) is planarly and contactably attached to the first structurally stable (503) panel through an adhesive layer (505); wherein, optionally, the WRB layer (507) exceeds the dimension of the first structurally-stable panel (503) from at least one of its edges to create an extension flap (509); and wherein the extension flap (509) of the WRB layer further comprises a removably-attached release-liner (511) attached to the WRB layer's inner surface.

### Embodiment 6

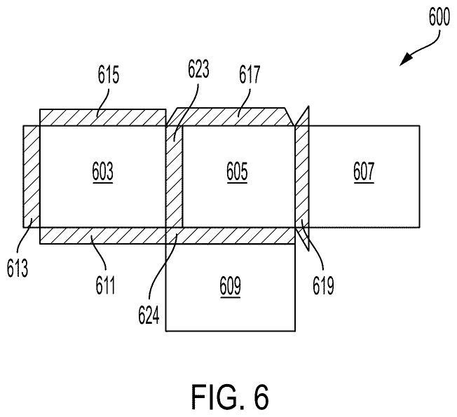

As shown in FIG. 6, in one embodiment, this invention relates to a panel assembly comprising at least two panels juxtaposed and/or adhered to each other, wherein at least one panel is according to the embodiments described above, that is, Embodiments 1-5.

In one embodiment, this invention relates to a panel assembly comprising at least two panels juxtaposed and/or adhered to each other, wherein the panel assembly consists of Embodiments 1.

In one embodiment, this invention relates to a panel assembly comprising at least two panels juxtaposed and/or adhered to each other, wherein the panel assembly consists of Embodiments 2.

In one embodiment, this invention relates to a panel assembly comprising at least two panels juxtaposed and/or adhered to each other, wherein the panel assembly consists of Embodiments 3.

In one embodiment, this invention relates to a panel assembly comprising at least two panels juxtaposed and/or adhered to each other, wherein the panel assembly consists of Embodiments 5.

In one embodiment, this invention relates to a panel assembly comprising at least two panels juxtaposed and/or adhered to each other, wherein the panel assembly consists of Embodiments 1, 2, 3, or 5, and wherein the extension flap at least on one edge of the structurally stable panel includes one or more types of the extension flap designs shown in FIG. 4.

In one embodiment, this invention relates to a panel assembly comprising at least two panels juxtaposed and/or adhered to each other, wherein the panel assembly consists of Embodiments A, B, and/or C.

See, for example, FIG. 6, wherein the panel assembly 600 comprises of panels 603, 604, 607, and 609, with the sealing done by the release liner removal from the back of the WRB layer, shown by shaded portion in the depiction, at its one or more edges 611, 613, 615, 617, 619, 621, and 623.

### II. Insulation Facer Layer

A problem encountered when using thin insulation sheathing is physical damage from bending, impact, or breaking. Such damage may occur by acts of vandalism, high velocity winds, rain, hail, construction practices, and the like. For example, in construction, it is common for ladders placed against vertical walls to bend, damage, or even break the insulation sheathing. It is also common for construction personnel to kneel upon insulation boards during construction.

Also, foam insulation boards are subjected to oxygen- and water-vapor-transmission and structural damage, both of which, over time, contribute to deteriorating the insulation properties and reducing the structural integrity of the board. A technique to address the problems of physical damage and loss of insulation properties is to apply or adhere a facing material (called a “facer”) to at least one side of the board. Examples of such facing materials include plastic film, thin metal foil, paper or thin cellulose, non-woven polymeric fabrics, fiberglass scrims, and combinations of the foregoing.

Important properties of facers include serving as moisture vapor and oxygen transmission barriers, providing strength and structural integrity, ease of application, and the like. Thin metal foils, such as aluminum, are commonly utilized in facers to provide moisture-vapor-and oxygen-transmission barrier properties.

Many laminates and/or facers for use in covering foam insulation boards and other products are described in the prior art. Such laminates are described in U.S. Pat. Nos. 6,872,673; 6,355,701; 6,093,481; 6,044,604; 5,695,870; 5,565,252; 5,345,738; 5,044,705; 4,985,106; 4,764,420; 4,572,865; 4,509,307; 4,284,674; 4,254,173; and 3,903,346. It is desirable to provide a laminate and/or facer for uses that require improved oxygen- and moisture-vapor barrier properties, structural integrity, strength, and weatherability.

It should be noted that all references cited above, and otherwise, in this specification are incorporated in this specification as if they were fully set forth herein.

Patterns are embossed as described later in this specification on the insulation facers. In one embodiment, one or more of the following patterns are embossed.

### Geometric Pattern

By geometric pattern is mean vertical lines, horizontal lines, transverse lines, crisscross lines, lattice, circles, triangles, squares, rectangles, trapezoid, rhombus, pentagons, and other such geometric designs. More than one type of geometric structure may be present on the surface of the insulation facer in an embossed or recessed fashion.

### Regular Pattern

By a regular pattern is meant that the same pattern is repeated in partial or full surface of the insulation facer. In other words, a geometric pattern would be repeated, or an irregular pattern would be repeated.

### Irregular Pattern

By irregular pattern is meant the insulation facer has a random design that is not regular.

### Embossing

By embossing herein is meant a relative difference in depth between the embossed pattern and the recessed pattern on the surface of the insulation facer. For example, if a pattern is embossed on the insulation facer surface, it covers the aspect where the same design is embossed or recessed. In one aspect, the textured surface is characterized by an embossed pattern of features or indentations. As used herein, “embossing” can mean embossing, debossing, scoring, or any other means to alter the texture of the facer.

Generally, separate steps are needed to create a system that is insulative, vapor semi-permeable, a weather resistive barrier, and acts as a drainage plane. The steps may include exterior insulation and a weather-resistive barrier that may or may not meet drainage needs through an outward facing attachment to the film, and placing an additional medium to the wall system to promote drainage.

### III. Insulation System

In one embodiment, the panel comprises an insulation system. The insulation system comprises at least two insulation layers, wherein at least one of the insulation layers is an open-celled foam insulation layer Stated differently, the insulation system of the present invention comprises two or more layers, wherein at least one layer is an open-celled foam insulation layer, and one layer is a regular foam insulation layer.
In a preferred embodiment, the regular foam insulation layer and the open-celled foam insulation layer are adjacent each other and are in adhesive contact with each other. But this invention also envisions a system where more than one open-celled foam insulation layers are adhesively stacked to each other and the entire stack is in adhesive contact with one or more of regular insulation foam layers.
If more than one regular foam insulation layer is stacked, in one embodiment, each of the stacked regular foam insulation layers is of the same chemical and/or physical configuration. In another embodiment where more than one regular foam insulation layers are stacked, at least one of the stacked regular foam insulation layers is different physically and/or chemically from at least one other regular foam insulation layers.
In yet another embodiment, where the open-celled insulation foam layers are stacked, at least one of the stacked open-celled insulation foam layers is different physically and/or chemically from at least one other open-celled insulation foam layers.

### IIIA. Insulation Layer

### Insulation Foam

Thermal insulation sheathing offers thermal barrier properties desirable for enclosures having regulated temperatures, including houses, offices, refrigerated containers, and the like. Extruded polymer foam articles such as polystyrene foam boards are thermal insulation materials for use in such enclosures including building and construction applications as well as thermal insulation containers. See for example, WO2018098570A1.

The thermal insulation sheathing that can be cut up into boards are commonly used to enhance insulation of building structures. Relatively thin (about ¼ inch to about 3.0 inches), rectangular panels of foam board are commonly placed between the dry wall and building exteriors such as stone, brick, wood, stucco, and the like. Insulation boards employed in such applications may include, but are not limited to, those utilizing polyisocyanurate foam and extruded polystyrene, polyolefin, and polyurethane foams and beads.

It would be advantageous if such insulation sheathing also provided a weather-resistive barrier that aids in removal of moisture and waterproofing.

The thermal insulation sheathing comprises foams of thermoplastic resins such as, for example, polystyrene and polyethylene, and polyurethane. Foams can be open-celled, close-celled and/or a mixed-cell structure.

In one embodiment, the insulation foams are made of extruded polystyrene, expanded polystyrene, polyethylene, polypropylene, or polyurethane.

They are useful industrial products because of their excellent heat-insulating, cushioning and other properties. These foams have found acceptance over the years in such applications as thermal insulation and cushioning as well as raw material for the fabrication of various shaped articles. The preparation of thermoplastic foams by extruding a heat-plastified mixture of a thermoplastic resin and a blowing agent is well known in the art and is described in U.S. Pat. Nos. 2,740,157; 3,067,147; 3,413,387; 3,413,388; 3,431,163; 3,431,164; 3,954,929 and 3,966,381 and Canadian Pat. No. 451,864. Similarly, various methods of preparing open or close-celled expanded polystyrene and other thermoplastic resins are described in art such as U.S. Pat. Nos. 3,243,485; 3,922,328; 4,399,086; 5049328; 5,271,886; and 7,358,280; U. S. Pat. App. Pub. Nos. US20020117769, US20130266766; and EPO patents EP0242191A2 and EP1995273A2. All art cited in this document is incorporated by reference as if fully set forth herein.

Current weather-resistive barriers that claim drainage capability are sheet films that have an external application of adhesive or coating that provides an offset for potential drainage.

In U.S. Pat. No. 6,355,333, granted to Waggoner et al., a Construction Membrane is taught. The membrane is described as resisting liquid and air penetration, being moisture vapor permeable, and being provided with integral drainage channels. The disclosed exterior wall construction which incorporates this membrane may be faced with stucco, siding, brick, or stone.

An Exterior Building Cladding Having Rigid Foam Layer With Drain Channels is shown in U.S. Pat. No. 6,886,301, granted to Schilger. Both the inside and the outside faces of the rigid foam insulation layer are provided with vertical channels 21 to remove moisture by way of thin channels 22. Exterior water penetration drains to the bottom of channels 22, and exits the wall construction by means of a drain wick 28 and flashing 25.

In Published Patent Application No. US 2011/0296781, owned by McCary, an Insulating Finishable Panel is illustrated. This construction employs a rigid-faced foam cored panel, which, in one embodiment includes foam air spacers adhered to the panel's radiant reflective surface. In another arrangement, attached foam air spacers create an air space between the insulation and the radiant reflective surface.

In Published Patent Application No. US 2008/0034690, to Gartz et al., an Underlayment With Improved Drainage is disclosed. The underlayment may include a plurality of vertical channels, and funnels at respective top and bottom edges. The funnels are provided to compensate for misalignment of vertically stacked underlayment panels.

Notwithstanding coats of paint and moisture sealant applied to the exterior layer of a stucco wall, moisture still manages to penetrate the stucco over time, and collect on layers of material within the wall. Known prior art construction methods provide moisture barriers and attempt to allow the drainage of accumulated moisture. However, these methods have proven inadequate, and stucco walls continue to fail from moisture intrusion and accumulation, allowing mold to form and causing wood to rot. The exterior stucco wall construction disclosed herein, provides improved drainage of the moisture which has penetrated the wall and collects therein on materials and structures. Improved longevity and integrity of the stucco wall system is thereby provided.

The insulation layer can comprise any suitable insulation material conventionally known to one of ordinary skill in the art. For example, the insulation layer can comprise a foam polymer insulation, including for example and without limitation, polyisocyanurate foam, polystyrene foam, polyurethane foam, or any combination thereof. In further exemplary aspects, the foam insulation layer comprises polyisocyanurate foam. In still further aspects, the foam insulation layer can comprise a blend or combination of a polyisocyanurate and polyurethane foam.

The foam insulation layer can comprise extruded foam, expanded foam, or a combination thereof. As one of ordinary skill in the art will appreciate, extruded foams can be prepared by melting a suitable polymer material, incorporating a blowing agent to yield a foamed gel, and extruding the foamed gel through a die to form the desired foam layer. Expanded foams can be prepared by subsequent expansion of beads containing a blowing agent, wherein the expanded beads are molded at the time of expansion to form the desired foam layer.

The foam insulation can have any desired density. For example, the foam insulation can have a density of at least about 1, 2, 3, 4, 5, 6, 7, 8, 9, 10, 11, 12, 13, 14, 15, 16, 17, 18, 19, or even at least about 20 pounds per cubic feet (pcf) according to ASTM D1622. In further aspects, the foam insulation can have a density in the range of about 1 pcf to about 20 pcf. In still further aspects, the foam insulation density can be any desired value within any range derived from any of the above exemplified values, including, for example, a density in the range from about 2 to about 5 pcf, or from about 1 to about 10 pcf.

The foam insulation can be either closed cell or open cell. Open cell foam is more likely to let water vapor condense inside the cells, thereby reducing the insulation value. Thus, in further exemplary aspect, the foam insulation is closed cell. In a further aspect, the foam insulation is greater than about 50, 60, 70, 80, or even greater than about 90% closed-cell according to ASTM D2856.

Since water can negatively impact thermal performance, the foam insulation preferably exhibits limited or substantially no water absorption. For example, the foam insulation exhibits a water absorption of less than about 10, 9, 8, 7, 6, 5, 4, 3, 2, or even less than about 1% according to ASTM C209. In a further aspect, the foam insulation exhibits a water absorption of less than about 10, 9, 8, 7, 6, 5, 4, 3, 2, or even less than about 1% according to ASTM C2842. In a still further aspect, the foam insulation can exhibit a water absorption in the range of about 10 to about 0%. In a yet further aspect, the water absorption can be any desired value within any range derived from any of the above exemplified values, including, for example, a water absorption in the range from about 0 to about 5%, or from about 1 to about 3.5%.

Moreover, the foam insulation layer can have any desired water vapor permeance (or transmission) value. For example, the water vapor permeance can be about 20, 15, 10, 9, 8, 7, 6, 5, 4, 3, 2, 1, or even about 0 perms according to ASTM E96. In a further aspect, the water vapor permeance can be in the range of about 0 to about 20 perms. In a still further aspect, the water vapor permeance can be any desired value within any range derived from any of the above exemplified values, including, for example, a water vapor permeance in the range from about 0 to about 2 perms, or from about 1 to about 5 perms.

The insulation layer can have any desired thickness (t). This thickness (t) can be customized to fit any particular application and desired thermal resistance. For example, and without limitation, the thickness of the foam insulation layer can be in the range of from about 0.25 in. (¼″) to about 3 in. (3″). In further aspects, the thickness can be from about 0.5 in. to about 1 in. Depending on the intended application, the panel can have any desired thermal resistance value (R-value). For example, the panel can have a R-value of at least about 1, 2, 3, 4, 5, 6, 7, 8, 9, 10, 15, 20, 25 according to ASTM C1289-02. In a further aspect, the R-value can be in the range of about 1 to about 25. In still further aspects, the R-value can be any desired value within any range derived from any of the above exemplified values, including, for example, R-value in the range from about 1 to about 10, or from about 3 to about 7.

In various aspects, the insulation layer can optionally comprise a membrane layer. The insulation membrane layer can comprise radiant barrier material, such as metal foil, for example, aluminum foil, polymeric film or fabric, paper or cellulosic material, reinforcing scrim, such as fiberglass scrim, or a combination thereof. In some aspects, the membrane layer comprises a single or multi-layered material which can be a laminate in which a backing material is laminated to a foam insulation layer. In other aspects, one or more optional additives can also be incorporated into or otherwise applied to the foam insulation layer. Exemplary and non-limiting additives can include flame retardants, colorants, ultraviolet absorbers, textured coatings, and the like as well as any combinations thereof.

The insulation layer can be secured to the inward facing surface of the panel, for example, by any conventionally used adhesive material known in the art to be compatible for use with foam insulation. For example, according to non-limiting aspects of the invention, the adhesive can be selected from a phenol-formaldehyde resin, hot-melt adhesive, polyvinyl acetate (PVA) resin, or any combination thereof. In still a further aspect, the adhesive can be isocyanate-based.

The insulated panels disclosed herein can exhibit improved physical strength and durability over traditional sheathing panels or foam panels. Thus, in one aspect, the inventive insulated panels can exhibit enhanced structural strength and dimensional stability when compared to a conventional or reference sheathing panel in the absence of the insulation layer when exposed to substantially the same environmental and/or physical forces under substantially similar conditions. To that end, the foam insulation layer can have a dimensional stability of about less than 5, 4, 3, 2, or even less than about 1% according to ASTM D2126. In a further aspect, the dimensional stability is preferably about less than 2%. The foam insulation layer can also have any desired compressive strength. For example, the foam insulation layer can have a desired compressive strength of at least about 1, 5, 10, 15, 20, 25, 30, 35, 40 pounds per square inch (psi) according to ASTM D1621. In a further aspect, the compressive strength can be in the range of about 1 to about 40 psi. In a still further aspect, the compressive strength can be any desired value within any range derived from any of the above exemplified values, including, for example, a compressive strength in the range from about 15 to about 30 psi, or from about 20 to about 25 psi. Likewise, the foam insulation layer can have any desired tensile strength. For example, the foam insulation layer can have a tensile strength of greater than about 300, 400, 500, 600, 700, 800, 900, 1000, 1500, 2000 pounds per cubic foot (pcf) according to ASTM D1623. In a further aspect, the tensile strength can be in the range of about 300 to about 2000 pcf. In a still further aspect, the tensile strength can be any desired value within any range derived from any of the above exemplified values, including, for example, a tensile strength in the range from about 500 to about 1000 pcf, or from about 600 to about 800 pcf.

In further aspects, the structural properties of the disclosed insulated panels make the insulated panels suitable for use in numerous structural applications, while still providing improved thermal performance. For example, in one aspect, the inventive insulated panels can be used as braced wall panels, when used in accordance with 2006 IBC Section 2308.3 and 2006 IRC Section R602.10.1. In another aspect, the inventive insulated panels are considered equivalent to Construction Method 3 described in Section 2308.9.3 of the 2006 IBC and Section R602.10.3 of the 2006 IRC. In another aspects, the inventive insulated panels are suitable for use an alternative to wood structural panels in the construction of wood shear walls, when installed in accordance with 2006 IBC Section 2305.3.

It should be noted that all references cited above, and otherwise, in this specification are incorporated in this specification as if they were fully set forth herein.

In one embodiment, the foam insulation is expanded Polystyrene (EPS), Extruded Polystyrene (XPS), Graphite Polystyrene (GPS), or polyisocyanurate foam insulation.

Expanded Polystyrene Insulation, more commonly referred to as EPS, is a closed cell insulation made commonly with of 98% trapped air and only 2% plastic. In one embodiment, this invention relates to a flat board, a contoured shape, or a combination of flat and contoured shaped EPS.

Extruded Polystyrene, referred to as XPS, is a closed cell insulation product commonly used in remodeling and new construction applications. In one embodiment, this invention relates to a flat board, a contoured shape, or a combination of flat and contoured shaped XPS.

Graphite polystyrene insulation, or GPS, is made from Neopor beads, patented and manufactured by BASF. Neopor gives GPS insulation a dark gray appearance and higher r-value than traditional EPS insulation products. In one embodiment, this invention relates to a flat board, a contoured shape, or a combination of flat and contoured shaped GPS.

Polyisocyanurate foam boards may include closed-cell polyisocyanurate (polyiso) foam insulation. This is described, for example, in U.S. Pat. No. 10,829,939B2, which is incorporated by reference herein.

In one embodiment, this invention relates to a system of panels described herein, wherein at least one panel comprises EPS, or at least one panel comprises XPS, or at least one panel comprises GPS, or at least one panel comprises polyisocyanurate foam, or at least a combination of two out of the four panels, three of the four panels, or all four panels. In another embodiment, the panels may be organized adjacent each other or separate from each other.

In one embodiment, this invention relates to an insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the fire-proofing layer as described previously.

In one embodiment, this invention relates to an insulation sheathing system that comprises two insulation sheathing panels: a first insulation sheathing panel and a second insulation sheathing panel. The two panels are juxtaposed side by side in one plane. Each insulation sheathing panel comprises the insulation foam layer and the fire-proofing as described previously.

In one embodiment, the panel has more than 2 sides. Stated differently, the present invention envisions a panel comprising, the following sides: 3, 4, 5, 6, 7, 8, 9, 10, 11, 12, 13, 14, 15, 16, 17, 18, 19, 20.

In one embodiment of the invention, the panel has a curved shape, for example, it is circular, or oblong shaped or a semi-circle shaped. In one embodiment of the invention, the panel has at least one side that is not linear, but has a curved shape.

In one embodiment, the multiple-sided panel has all sides that are equal or at least two sides that are equal or no sides that are equal in length.

This invention envisions an insulation sheathing panel system comprising at least two panels wherein a first panel is irregular shaped, but the adjacent juxtaposing second panel neatly fits with the irregular shape of the first panel.

In one embodiment, the insulation panel system comprises more than one square or a rectangular panel, wherein each side of the panel has a tongue or groove configuration.

In one embodiment, the insulation sheathing includes extruded polystyrene, polyisocyanurate, polyolefin, and polyurethane foams and beads.

### IIIB. Open-Celled Foam Insulation Layer

The open-celled foam insulation layer as adhesively in contact with the regular foam insulation layer described previously.

In one embodiment, the open-celled foam insulation layer comprises a sprayable foam that is made from polyurethane sprayable foams, polyurea sprayable foams, and combinations thereof. In another embodiment, the sprayable foam may be selected from the group of acrylic foams, latex foams, melamine foams, isocyanurate foams, and silicone foams. When the sprayable foam is the polyurethane sprayable foam, the sprayable foam may be the reaction product of a polyether polyol and an isocyanate. Alternatively, the polyurethane sprayable foam may be the reaction product of a polyester polyol and the isocyanate. The use of the polyester polyol imparts the insulating foam layer with a fire-retardant characteristic. When the sprayable foam is the polyurea sprayable foam, the sprayable foam is the reaction product of a polyamine and an isocyanate. An example of an isocyanate suitable for the sprayable foam is lubrinate. The insulating foam layer may include additives, such as fire retardants, and impact modifiers.

The open-celled spray foam acts as a water barrier that also is not air-permeable. In one embodiment, the open-celled spray foam is an air and water barrier, while still being water vapor permeable.

Polyurethane foam is used as an example to describe the open-celled foam herein.

In one aspect, the open-celled polyurethane with the open cell structure has a density of between 0.60 and 1.5 lb. per cubic foot. In one embodiment, the density of the foamed open cell polyurethane foam is between 0.90 and 1.20 lb. per cubic foot, and in yet another embodiment, between 1.00 and 1.15 lb. per cubic foot.

In one aspect, the open cell structure of the foams of the present invention have a structure wherein the cells are essentially open but include some randomly occurring, solid cell walls.

The term “open-celled, foamed polyurethane” refers to polyurethane materials having a cell structure which is at least partially open, and thus, has few, if any, fully entrained voids (e.g., closed cells) within the polyurethane material. It should be noted that the phrase “open cell” as used herein with reference to foams of the present invention indicates that substantially all cells have at least one cell wall which is at least partially open, or ruptured, so that gas, and in particular, water vapor, may escape from the foam structure. However, the entire foam, as a whole, acts to prevent the passage of liquid water, or the passage of air, and thus acts as a water and air barrier. The open cell structure is also preferably non-shrinking, since the cell structure is not influenced by the expansion and contraction of gas bubbles, as can be seen in some closed cell foam materials.

In one aspect, the open cell structure of the foams is formed by the effect of a surfactant interaction that produces both completely open and at least partially open, cell walls.

If measured by a method such as ASTM D6226, the open cell content of the foams of the first open-celled foam insulation layer of the present invention, in one embodiment is greater than 85%, or 90%, or 95%, or 98%. As such, the level of entrained voids in the foams of the present invention might be as high as 50%, by number, of the total number of cells in the foam. In one embodiment, however, the level of entrained voids in the polyurethane foam is less than 25% by number, or even less than 10%, by number.

The open cell polyurethane foam of the present invention can also include a continuous “skin” portion formed on one or more surfaces of the foam. The skin provides a smooth surface that can prevent ingress of water, and thus can function as a water barrier, and aids initially in causing water to bead off of the surface of the foam. However, the skin is not a solid structure, and should not act to significantly affect the ability of water vapor to pass through the open cell polyurethane foam material.

The size of the cell can vary depending on the materials used, and the amount of blowing agent, and the like that is used. In one embodiment, the foams of the present invention have a cell size of between 0.03 um, and 1.5 um, and more preferably between 0.1 um and 1.0 um. More preferably, the majority of cells have a cell size of 0.8 and 0.3 um.

The insulating ability (for example the “R” value) of the foam is preferably such that the polyurethane foam of the present invention will provide an R value of between 2 and 6 per inch of thickness, and more preferably, between 3 and 5 per inch of thickness. As such, typical “R” values would be between the ranges of 4 and 12 for a 2 inch thickness foam.

In one aspect, the present invention provides a semi-rigid, polyurethane foam, for use in insulating, wherein said sprayed polyurethane foam has an open cell structure and density, as previously described with respect to the present invention.

The general production methods to produce polyurethane foams are well known to the skilled artisan, as is the general chemistry for production thereof. As such, these will not be described in any specific detail Depending upon the type of foam structure that is required by a specific application, the isocyanate and/or polyol resin systems may be selected according to their molecular weight. For example, low molecular weight materials tend to promote the formation of a more rigid material. To achieve a semi-rigid material, typically, a medium molecular weight resin system is typically used. To achieve a flexible foam, a high molecular weight resin system would preferably be used. The types of foam materials are discussed in US20160272772 and CA3045033 and both references are incorporated herein as if they were set forth, here, fully.

Further, as is known in the art, the foam structure of the polyurethane material is provided by a blowing agent which acts to form the voids within the polyurethane as it reacts and solidifies. The nature, types and amounts of blowing agents which are used in polyurethane foam manufacture are well known to those skilled in the art, but can include, for example, water, carbon dioxide, hydrofluorocarbons (HFCs), chlorinated fluorocarbons, hydrofluoro olefins (HFOs), and the like. Typically, water is the preferred blowing agent for formulations of the present invention. Alternatively, other blowing agents can be used, or combined with water, in order to generate a gaseous material during the curing reaction. While carbon dioxide is a preferred gas for generation, other gases such as nitrogen, pentane, HFOs, HFCs, or the like, may be released, or directly used, in order to form a foam with the desired density and cell shape and size. In addition to water, minor amounts of auxiliary blowing agents include: HCFC-22, HFC-134a, HCFC-142b, HFC-245fa, dichloroethylene, hydrocarbons such as n-pentane, isopentane, cyclopentane and the like.

In one embodiment, the foams are 100% water blown foams (both EPS and spray foam) for ultra-low environmental impact.

Additionally, other additives such as catalysts or surfactants, or the like, can be added to the reaction mixture in order to control various properties of the polyurethane foam. Other materials can be included for example, coupling agents, such as silane or titanates, may also be included in the preparation of the composition to improve the physical properties of the material. Where other properties are desired, additional additives may be added to the composition including colorants, dry or liquid inks or pigments, fire and flame retardants, UV absorbers and protectants, antistatic agents, and such other additives as required, and which are known within the industry.

### IV. Structurally Stable Panel

The structurally stable panels are an integral part of the IWS panel and is generally contactably and planarly adjacent the insulation layer. They can be made of wood, lignocellulosics, OSB, compalite, MgO and even gypsum. The wood-composite panel comprising plant-based materials.

As used herein, “wood” is intended to mean a cellular structure, having cell walls composed of cellulose and hemicellulose fibers bonded together by lignin polymer. “Wafer board” is intended to mean panels manufactured from reconstituted wood wafers bonded with resins under heat and pressure.

As used herein, “wood composite” or “wood composite material” it is meant a composite material that comprises wood and one or more other additives, such as adhesives or waxes. Non-limiting examples of wood composite materials include oriented strand board (“OSB”), waferboard, particleboard, chipboard, medium-density fiberboard, plywood, and boards that are a composite of strands and ply veneers. As used herein, “flakes” and “strands” are considered equivalent to one another and are used interchangeably. A non-exclusive description of wood composite materials may be found in the Supplement Volume to the Kirk-Othmer Encyclopedia of Chemical Technology, pp. 765-810, 6^{th} edition.

As used herein, “structural panel” is intended to mean a panel product, commonly composed of wood which, in its commodity end use, is essentially dependent upon certain mechanical and/or physical properties for successful end use performance such as plywood. A non-exclusive description may be found in the PS-2-92 Voluntary Product Standard.

The panel can comprise oriented strand board, plywood, particleboard, chipboard, medium-density fiberboard, or waferboard.

The structurally stable panel can also comprise at least one plant-based material, said other plant-based material are described as below:

grass, including perennial grass, switchgrass such as Panicum virgatum L, Miscanthus, Sorghum, sugarcane, millets, Napier grass, giant reed, and other forage and turf grasses, subalpine grasses, native grass, sedge, rush include Agrostis exarata (Spike Bentgrass), Ammophila arenaria (European sand dune or beach grass), Ammophila breviligulata (American beach grass), Ammophila champlainensis Seymour, Ammophila maritima, Beckmannia zyzigachne (American Sloughgrass), Bromus carinatus (California Brome), Bromus vulgaris (Columbia Brome), Carex densa (Dense-Headed Sedge), Carex feta (Green-Sheathed Sedge), Carex leporina (Harefoot Sedge), Carex lenticularis (=C. kelloggii) (Shore Sedge), Carex lyngbyel (Lyngby Sedge), Carex macrocephala (Big Headed Sedge), Carex obnupta (Slough Sedge), Carex pansa (Foredune Sedge), Carex unilateralis (One-Sided Sedge), Deschampsia caespitosa (Tufted Hair Grass), Eleocharis palustis (Creeping Spike rush), Elymus glaucus (Blue Wild Rye), Festuca idahoensis var. roemeri (Roemer's Fescuc), Festuca rubra var. littoralis (Shore Fescue), Festuca subulata (Bearded Fescue), Glyceria elata (Tall Mannagrass), Glyceriaoccidentalis (Western Mannagrass), Hordeum brachyantherum (Meadow Barley), Juncus effusus (Soft Rush), Juncus patens (Spreading Rush), Juncus tenuis (Slender Rush), Lozula campestris (Woodrush), Phalaris arundinacea (Reed Canary Grass), Phalaris aquatica, Phalaris tuberosa (Staggers Grass), Phalaris canariensis, Poa Macrantha (Dune Bluegrass), ReGreen (Sterile Hybrid Wheat), Scirpus acutus (Hardstem Bullrush), Scirpus americanus, Scirpus cyperinus, Scirpus maritimus (Seacoast Bullrush), Scirpus microcarpus, Scirpus validus, Sparaganuim eurycarpum (Giant Burreed), Triglochin maritinum (Seaside Arrowgrass), Typha latifolia (Cattail), Alopecuris geniculatus, Carex pachystachya, Carex stipata (grass like), Danthonia californica, Eleocharis ovata (grass like), Glycaria grandis, Juncus acuminatus, Juncus bolanderi and Juncus ensifolius (Daggar leaf rush). By way of example, other grasses include the Lily of the Nile (Agapanthus africanus), white fountain grass (Pennisetum ruppellii), muhly grass (Muhlenbergia capillaris), African iris (Dietes vegeta), podocarpus (Podocarpus macrophyllus), wax myrtle (Myrica cerifera), Aztec grass (Ophiopogon intermedius argenteomarginatus), mondo grass (Ophiopogon japonicus), evergreen giant (Liriope muscan), evergreen Paspalum (Paspalum quadrifarium) and sand cord grass (Spartina bakerii).

Further the structurally stable panel comprises other plant-based materials, said other plant-based materials comprise flax straw, which is flax fibers and flax shives produced from processing waste flax straw. Waste flax straw is made during the harvesting of flaxseeds from flax plants. The flax straw includes a mixture of flax fibers and flax shives. In another embodiment, the lignocellulosic component includes bio-waste cotton (Gossypium hirsutum L.) stalks and underutilized paulownia (paulownia fortunic). In yet another embodiment, the wood composite includes waste stone pine (Pinus pinea L.) cones, needle litter of Scotch pine (Pinus sylvestris L.), corn stalks, vine pruning stalks, sycamore leaves, reed stem, or hevea brasiliensis clones. In yet another embodiment, the lignocellulosic component comprises corn stover, rice straw, wheat straw, barley straw, oat straw, rape seed straw, siteria grass, yukka fibre, lemongrass, jute, sisal, bamboo, pine needles, lupins, kenaf, coir fiber, coconut husks, cotton stalks, coffee husks, ground nut husks, areca nut husks, casaurina leaves, banana leaves and banana stem.

In one embodiment, the structurally stable panel is a composite board such as the EcoStorm® coverboard obtained from Carlisle Corporation of Mechanicsburg, Pennsylvania. The EcoStorm® coverboard is an engineered composite building material made from a blend of plastic and cellulose fiber. In one embodiment of the invention, the composite board is sourced from post-industrial and post-consumer waste streams. In another embodiment, such composite board is a durable, moisture and mold resistant building material.

### V. Weather-Resistive Barrier Layer

By “weather-resistive barrier layer” (“WRB layer”) is meant the external house-wrap layer that provides barrier properties but may have water vapor permeability. House wraps are described for example in U.S. Pat. Nos. 6,901,712.

In one embodiment, the WRB layer is a preformed sheet air barrier membrane, which is permeable to water vapor and which can be adhered to a substrate, substantially over its entire area, by virtue of an adhesive deposited on one side of the sheet. In the present invention, the substrate is a wood panel as described supra.

In another embodiment, the WRB layer provides a pattern for depositing the adhesive on the membrane such that the lateral movement of air between the membrane and the substrate or through lap joints of membrane sections is restricted.

In yet another embodiment, the WRB layer is a water vapor permeable, air barrier sheet membrane which can be installed with or without the use of mechanical fasteners, nails, screws or tapes to provide an air barrier system with a continuous plane of air tightness.

In another embodiment, the WRB layer has an adhesive backed water vapor permeable sheet membrane that can perform as a barrier to the infiltration of liquid or bulk water as from wind-driven rain, when used in wall and roof assemblies.

In one embodiment, the WRB layer is a membrane permeable to water vapor, on one side of which is deposited an adhesive in a non-continuous film leaving zones of uncoated membrane, thereby permitting the diffusion of water vapor through the membrane at the uncoated zones.

In another embodiment of the WRB layer, the adhesive is deposited in a pattern on the membrane such that the adhesive intersects or connects in a manner to avoid providing channels through which air can laterally migrate when the membrane is bonded to a substrate.

In another embodiment of the WRB layer, the membrane, although permeable to water vapor, is rendered impermeable to liquid or bulk water and can thus perform as an adhesive backed moisture barrier which is permeable to water vapor.

In another embodiment, the WRB layer is a self-adhering, water vapor permeable, air and moisture barrier sheet for structural surfaces of buildings, comprising (i) an air and moisture barrier membrane which is water vapor permeable, and (ii) has an adhesive applied to one side of the water vapor permeable membrane in a non-continuous film.

In accordance with a particular embodiment of the invention, there is provided a self-adhering sheet for structural surfaces, comprising, (a) an air and moisture barrier membrane having opposed first and second faces, said membrane being water vapor permeable, and (b) an adhesive applied to said second face in a non-continuous film to define a plurality of spaced-apart, non-adhesive-coated zones surrounded by an adhesive coated zone.

In yet another aspect of the invention, WRB layer is an article of manufacture comprising a self-adhering sheet of the invention having a strippable release sheet removably adhered to said second face with a non-continuous adhesive film.

### WRB Layer—Vapor Permeable Membrane

The vapor permeable membrane of the invention is a flexible sheet or film, which is permeable to the passage of water in vapor form. The sheet or film may be microporous, microperforated or some other type of vapor permeable sheet or film.

A microporous sheet or film is a non-perforated continuous microfiber web with microscopic pores large enough for moisture vapor to pass through, but small enough to resist air and liquid water. Microperforated membranes depend on mechanical pin-perforations and/or film laminations to build in properties.

While both of the abovementioned types of sheet or film are permeable to water vapor, a sheet or film of the microporous type is preferred as this type is less permeable to the passage of water or moisture in liquid or bulk form.

Suitable microporous sheets or films are spunbonded or fibrous bonded polyolefin as described in U.S. Pat. Nos. 3,532,589 and 5,972,147, preferred polyolefins are polyethylene and polypropylene, one such microporous sheet is available commercially under the trade-mark Tyvek®; other suitable microporous sheets include oriented polymeric films as described in U.S. Pat. No. 5,317,035, and which comprise ethylene-propylene block copolymers; one such film is commercially available as Aptra®. The sheets or films may be reinforced with several types of scrim materials or may be laminated to other vapor permeable sheets or films, such as non-woven polypropylene or non-woven polyester for the purpose of improving strength and other physical properties.

In general, the membrane will typically have a thickness of 0.001 to 0.04, preferably 0.001 to 0.025 inches.

The WRB layer can extend at one or more edges of the panel as the extension flap, wherein the extension flap comprises a removably attached release liner on its back side.

In one embodiment, the extension flap of the WRB extends in length from about 0.2% of the minimum dimension of the panel to about 50% of the length of the maximum dimension of the panel. In one embodiment, the adhesive on the inner surface of the WRB that adheres to the wood layer is the same as the adhesive on the extension flap of the WRB having a removably attached release liner.

In one embodiment comprising the extension flaps or pre-applied tapes, the overhang is anywhere from 0.1 inches to 12 inches on any one or more edges of the panel. This is advantageous is minimizing or to eliminating the need for labor to tape the seams in the field.

### VI. Optional Fastener-Gasketing Adhesive

The fastener-gasketing adhesive can be a hot-melt adhesive, solvent based adhesive, water based adhesive or of other types such as UV cured polymer. The applied adhesive is preferably tacky, i.e., sticky and pressure sensitive. Suitable hot melt adhesives may contain such ingredients as polymers such as butyl rubber, styrene-butadiene-styrene (SBS), styrene-isoprene-styrene (SIS), styrene butadiene (SB), styrene-ethylene-butadiene-styrene (SEBS) and ethylene vinyl acetate (EVA); resins such as those of the hydrocarbon and rosin types, natural and petroleum waxes, oils, bitumen and others. Solvent-based adhesives may contain ingredients such as those listed above, dissolved or dispersed in a solvent vehicle. Water based adhesives would normally be based on emulsions of polymeric materials. Suitable polymeric materials would include vinyl acetate and acrylic polymers and copolymers such as vinyl acetate acrylic, ethylene vinyl acetate as well as styrene acrylic, vinyl chloride acrylic, vinyl versatate and others.

From a production standpoint, the preferred adhesives are of the hot melt type which are simply melted for application and need not emit solvent which is an environmental pollutant and may require re-condensation. Water based adhesives have the disadvantage that they generally require the additional use of drying ovens or heat lamps to evaporate the water.

The adhesive may suitably be applied at a thickness of 0.001 inches to 0.1 inch but is preferably applied at a thickness of 0.003 inches to 0.025 inches and most preferably at a thickness of 0.005 inches to 0.02 inches.

The WRB layer is adhered to a wood-composite material layer or a panel, with an adhesive. The WRB layer extends beyond the panel dimensions in one or more directions away from the edges. For example, if the panel is rectangular, with the WRB layer attached to it. The WRB layer will extend at least 0.1 inch over the dimension of the rectangular panel on one or more sides. In these extension flaps of the WRB panel will be attached a release liner that is attached with an adhesive material, such that when more than one panel is abutted to each other, upon removal of the release liner the WRB layer adhered directly to the adjacent panel of the assembly, and will seal the gaps between the two panels in the assembly.

Suitable release sheets are paper sheet, having a silicone release surface coating and some treated plastic films.

### Adhesive Pattern

To retain an essential level of water vapor permeance in the adhesive coated membrane, the adhesive is applied to the vapor permeable membrane in a non-continuous film in order to leave parts, or spots or zones of the sheet uncoated with adhesive.

In order to prevent the lateral movement of air between the membrane and the substrate to which it is bonded, and through lap joints of the membrane, the adhesive coated areas of the membrane can be made to intersect to isolate the uncoated areas, thereby eliminating channels through which air can laterally move. This can be achieved by any number of patterns, such as intersecting circles with adhesive free centers, intersecting squares or rectangles of adhesive, intersecting strips in a checkered pattern, and the like.

In general, the adhesive film forms an adhesive sea on the membrane surface, with a multitude of membrane islands, surrounded by but not covered by the adhesive sea.

The adhesive may suitably be applied so as to cover 5% to 99% of the area of one side of the membrane but is preferably applied to cover between 25% and 90% of the area, and most preferably between 50% and 80% of the area, to obtain the optimum balance of adhesion and vapor permeance in the sheet.

### VII. Optional Adhesive Layer

The adhesive can be a hot-melt adhesive, solvent based adhesive, water based adhesive or of other types such as UV cured polymer. The applied adhesive is preferably tacky, i.e., sticky and pressure sensitive. Suitable hot melt adhesives may contain such ingredients as polymers such as butyl rubber, styrene-butadiene-styrene (SBS), styrene-isoprene-styrene (SIS), styrene butadiene (SB), styrene-ethylene-butadiene-styrene (SEBS) and ethylene vinyl acetate (EVA); resins such as those of the hydrocarbon and rosin types, natural and petroleum waxes, oils, bitumen and others. Solvent-based adhesives may contain ingredients such as those listed above, dissolved or dispersed in a solvent vehicle. Water based adhesives would normally be based on emulsions of polymeric materials. Suitable polymeric materials would include vinyl acetate and acrylic polymers and copolymers such as vinyl acetate acrylic, ethylene vinyl acetate as well as styrene acrylic, vinyl chloride acrylic, vinyl versatate and others.

From a production standpoint, the preferred adhesives are of the hot melt type which are simply melted for application and need not emit solvent which is an environmental pollutant and may require re-condensation. Water based adhesives have the disadvantage that they generally require the additional use of drying ovens or heat lamps to evaporate the water.

The adhesive may suitably be applied at a thickness of 0.001 inches to 0.1 inch but is preferably applied at a thickness of 0.003 inches to 0.025 inches and most preferably at a thickness of 0.005 inches to 0.02 inches.

The WRB layer is adhered to a wood-composite material layer or a panel, with an adhesive. The WRB layer extends beyond the panel dimensions in one or more directions away from the edges. For example, if the panel is rectangular, with the WRB layer attached to it. The WRB layer will extend at least 0.1 inch over the dimension of the rectangular panel on one or more sides. In these extension flaps of the WRB panel will be attached a release liner that is attached with an adhesive material, such that when more than one panel is abutted to each other, upon removal of the release liner the WRB layer adhered directly to the adjacent panel of the assembly, and will seal the gaps between the two panels in the assembly.

Suitable release sheets are paper sheet, having a silicone release surface coating and some treated plastic films.

### Adhesive Pattern

To retain an essential level of water vapor permeance in the adhesive coated membrane, the adhesive is applied to the vapor permeable membrane in a non-continuous film in order to leave parts, or spots or zones of the sheet uncoated with adhesive.

In order to prevent the lateral movement of air between the membrane and the substrate to which it is bonded, and through lap joints of the membrane, the adhesive coated areas of the membrane can be made to intersect to isolate the uncoated areas, thereby eliminating channels through which air can laterally move. This can be achieved by any number of patterns, such as intersecting circles with adhesive free centers, intersecting squares or rectangles of adhesive, intersecting strips in a checkered pattern, and the like.

In general, the adhesive film forms an adhesive sea on the membrane surface, with a multitude of membrane islands, surrounded by but not covered by the adhesive sea.

The adhesive may suitably be applied so as to cover 5% to 99% of the area of one side of the membrane but is preferably applied to cover between 25% and 90% of the area, and most preferably between 50% and 80% of the area, to obtain the optimum balance of adhesion and vapor permeance in the sheet.

### Primer

As is common with other types of self-adhering membranes, the use of a liquid primer coating may sometimes be recommended to improve adhesion of the membrane to some substrates such as wood panel. In the case of a vapor permeable membrane, the primer should be selected from certain materials or applied at a reduced rate or in a manner such that the breathability of the assembly is not compromised.

### Vapor Impermeable Barrier Sheet

In some embodiments, the vapor permeable membrane sheet of the invention is typically employed in a building structure, especially a wall structure, in conjunction with a vapor impermeable barrier sheet. A preferred sheet is a polyethylene sheet, as known in the art, having a water vapor permeance of not more than 15 ng/Pa·s·m² (ASTM E 96).

Such a sheet may be considered a vapor retarder since it is not completely impermeable to water vapor.

Typically, the barrier sheet has a thickness of 0.001 to 0.008 inches, more usually 0.002 to 0.006 inches.

### Insulation Sheathing and WRB Panels

In one embodiment, this invention relates to an insulation sheathing system that comprises two insulation wall-sheathing (IWS) panels: a first IWS panel and a second IWS panel. The two panels are juxtaposed side by side in one plane as described previously. In one embodiment, the insulation sheathing system comprises two IWS panels wherein at least one panel comprises at least one extension flap with a backing of a release liner, on one side of the panel. In another embodiment, the two panels are fitted or attached to each other via the extension flap arrangement, with the release liner now removed and the extension flap extending from one panel to the second panel and providing the joining of the two panels. Multiple panels can be similarly joined.

In one embodiment, the extension flap is continuous along the length of the side of the insulation panel from which it extends outward. In another embodiment, of the invention, the extension flap is discrete, with multiple protrusions which in totality make the extension flap. In one embodiment, there is a gap between the protrusions that form the extension flap. In another embodiment, the protrusions are of the same width or of different widths. See FIG. 4, generally.

### Tongue-and-Groove Arrangement

In an insulation wall-sheathing (IWS) panel, at least on one side of the panel either a tongue or a groove can be provided for its juxtaposition and attachment to an adjacent panel. By tongue is meant a protrusion along the length of the side of a panel that removably fits within the groove of an adjacent panel. By groove is meant a depression along the length of an insulation wall-sheathing panel which allows for a removable attachment of the side of an adjacent panel that has a tongue along its length.

In one embodiment, the tongue and the groove are a continuous feature along the length of a system comprising at least two insulation wall-sheathing panels. In another embodiment of the IWS panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one embodiment, this invention relates to an insulation sheathing system that comprises two insulation wall-sheathing panels: a first insulation wall-sheathing panel and a second insulation wall-sheathing panel. The two panels are juxtaposed side by side in one plane. In one embodiment, the insulation sheathing system comprises of the two panels wherein each panel comprises either a groove or a tongue at least on one side of the panel. In another embodiment, the two panels are fitted or attached or joined to each other via the tongue-and-groove arrangement. Multiple panels can be similarly joined.

In one embodiment, the tongue and the groove are a continuous feature along the length of a system comprising at least two insulation wall-sheathing panels. In another embodiment of the insulation wall-sheathing panel systems, the tongue and the groove arrangement is discrete such each tongue is divided into multiple protrusions along the length of the side of a panel, and the corresponding side of the receiving panel comprises multiple grooves in form of depressed troughs to receive the multiple protrusions. In one system, the tongue is discrete on one sheathing panel, but the receiving groove is continuous.

In one aspect of the invention, the invention relates to an insulation wall-sheathing panel or an insulation sheathing system (i.e., multiple panels), that have panels comprising both the extension flaps and the tongue-and-groove arrangement.

In one embodiment, the insulation wall-sheathing panel has more than 2 sides. Stated differently, the present invention envisions a panel comprising, the following sides:

3, 4, 5, 6, 7, 8, 9, 10, 11, 12, 13, 14, 15, 16, 17, 18, 19, 20.

In one embodiment of the invention, the panel has a curved shape, for example, it is circular, or oblong shaped or a semi-circle shaped. In one embodiment of the invention, the panel has at least one side that is not linear but has a curved shape.

In one embodiment, the multiple-sided panel has all sides that are equal or at least two sides that are equal or no sides that are equal in length.

This invention envisions an insulation wall-sheathing panel system comprising at least two panels wherein a first panel is irregular shaped, but the adjacent juxtaposing second panel neatly fits with the irregular shape of the first panel.

In one embodiment, the insulation panel system comprises more than one square or a rectangular panel, wherein each side of the panel has a tongue or groove configuration and each side has an extension flap with the releasable liner backing.

In one embodiment, the pattern on the insulation facer will also repeat in the machine direction of the insulation sheath being made. In one embodiment, the embossed design connects with each other for adequate drainage of the moisture. In one embodiment, the embossed design is vertical lines. In one embodiment, the embossed design is crisscross lines or a lattice design. In one embodiment, the design is rhombus or diamond shape. In one embodiment, the entire design is connected to each other. In one embodiment the design is a set of transverse lines. It is to be understood that the designs and/or patterns herein are in plurality and/or in repetition in the vertical or the horizontal (machine) direction.

This invention addresses the above issues of moisture drainage by providing a vapor semi permeable weather resistive drainage product in a single inline process through an embossment technique.

Particularly, in one of its embodiments, it includes a vapor semi-permeable insulation sheathing that provides insulation, a weather-resistive barrier, and an air barrier while simultaneously providing a drainage mechanism on the external surface, which has been engendered through an in-line application of pressure and heat. The patterned embossment on the sheathing provide an avenue for moisture that gets behind the exterior weather barrier a means to escape.

The comprehensive weather resistive barrier that includes an insulation component with an embossed drainage system allows the contractor minimal passes to create all functions while using a planar board that does not exceed the primary dimension of the sheathing. The design uses a polymeric film that is breathable and adhered to an insulative core material through heat lamination on one face that undergoes pressure and heat to create a mechanism to promote drainage when used as a wall system component. The patterned embossment in the sheathing will provide an avenue for moisture that gets behind the exterior weather barrier a means to escape.

In the present disclosure, insulation sheathing, insulation board, insulation panel, or insulation material is used interchangeably.

As discussed previously, insulation facing laminations are laminates which contain film/foil or metalized films that provide protection for a variety of insulation applications. Often the adhesive possesses fire-retardant properties. Typical applications include ceiling panels and wall insulation.

As shown in FIG. 1.1, of U.S. Prov. App. No. 63/505,711, which filing is incorporated in its entirety, by reference, herein, and in one embodiment, the insulation sheathing comprises an insulation foam and an insulation facer laminated on at least one surface of the insulation foam.

In one embodiment, such facing materials or insulation facers include plastic film, thin metal foil, paper or thin cellulose, non-woven polymeric fabrics, fiberglass scrims, and combinations of the foregoing.

In one embodiment, the insulation sheathing includes extruded polystyrene, polyisocyanurate, polyolefin, and polyurethane foams and beads.

The insulation facer comprises an embossed pattern on its surface. The pattern may be geometric, regular, or random. The embossed pattern is such that it aids in draining of the accumulating moisture on the surface of the insulation sheathing.

By geometric pattern is mean vertical lines, horizontal lines, transverse lines, circles, triangles, squares, rectangles, trapezoid, rhombus, pentagons, and other such geometric designs. More than one type of geometric structure may be present on the surface of the insulation facer in an embossed or recessed fashion.

By a regular pattern is meant that the same pattern is repeated in partial or full surface of the insulation facer. In other words, a geometric pattern would be repeated, or an irregular pattern would be repeated.

By irregular pattern is meant the insulation facer has a random design that is not regular.

By embossing herein is meant a relative difference in depth between the embossed pattern and the recessed pattern on the surface of the insulation facer. For example, if a pattern is embossed on the insulation facer surface, it covers the aspect where the same design is embossed or recessed.

The pattern will also repeat in the machine direction of the insulation sheath being made.

The embossed design on the insulation sheathing is such that insulation sheathing of the present invention has an advantageous moisture drainage or removal possibility. An embossed design is shown in FIG. 1.2 of U.S. Prov. App. No. 63/505,711.

In one embodiment, this invention relates to an exterior stucco wall construction comprising: a wall frame; sheathing attached to the outer side of the wall frame; a moisture collection channel or the embossed design mounted along the insulation sheathing facer, a second moisture impervious board comprising the insulation sheathing having an inner side insulation facer provided with drain means such as the embossed design described previously to facilitate the downward drainage of moisture.

Turning now to the drawings, and in particular FIG. 1.3 of U.S. Prov. App. No. 63/505,711, it shows the process of embossing the design on the insulation facer. At least one of the roller has a design template on its surface. The continuously moving insulation sheathing has an insulation facer on one or both surfaces. The insulation sheathing (with the foam and the facer) moves in the horizontal direction, in one example, and under temperature and/or pressure, the embossed design is imprinted. As shown in FIG. 1.4 of U.S. Prov. App. No. 63/505,711, a design for moisture removal is embossed on the facer of the foam insulation. This embossed design feature provides the maximum discharge of moisture and condensation. Experimentation includes creating a means to emboss the assembly while not deteriorating the weather resistive barrier or air barrier requirements. Further testing include permeance, wind driven rain, R-Value, compatibility, drainage and pressure testing of the assembly.

### EXPERIMENTAL EXAMPLES

In one embodiment, a pattern roller is applied to a rotary press. The sheet of foam which is laminated in line previously enters the roller with ¼″ pinch which creates pressure at a temperature in excess of 220° F. The pressure roller is spinning at 60 feet per minute. The material exits the roll and the pattern is embossed in the insulation sheathing on the facer side.

1. A first insulated wall-sheathing (IWS) panel used for construction purposes, comprising the following layers:
an optional insulation facer layer having an outer surface and an inner surface;
a first open-celled insulation layer having an outer surface and an inner surface; wherein, when the insulation facer layer is present, the inner surface of the insulation facer is planarly and contactably attached to the outer surface of the first open-celled insulation layer;
a first insulation layer having an outer surface and an inner surface; wherein the inner surface of the first open-celled insulation layer is planarly and contactably attached to the outer surface of the first insulation layer;
a first structurally stable panel having an outer surface and an inner surface, and at least one edge extending between its outer surface and the inner surface; wherein the inner surface of the first insulation layer is planarly and contactably attached to the outer surface of the first structurally stable panel; and
a first weather-resistive barrier (WRB) layer having an outer surface and an inner surface, wherein the inner surface of the WRB layer is secured to the outer surface of the first structurally stable panel through an adhesive layer, or through a fastener-gasketing layer, or through an adhesive layer and a fastener-gasketing layer;
wherein, optionally, the WRB layer exceeds a dimension of the first structurally stable panel from at least one of its edges to create an extension flap; and
wherein the extension flap of the WRB layer further comprises a removably attached release-liner attached to the WRB layer's inner surface.

2. The IWS panel as recited in claim 1, wherein the structurally stable panel is a wood-composite panel.

3. The IWS panel as recited in claim 2, wherein the wood-composite panel is a lignocellulosic panel.

4. The IWS panel as recited in claim 3, wherein the lignocellulosic panel is an OSB panel.

5. The IWS panel as recited in claim 1, wherein the open-celled insulation layer is a spray foam or EPS.

6. The IWS panel as recited in claim 5, comprising a blowing agent, wherein the blowing is in an aqueous medium.

7. The IWS panel as recited in claim 1, wherein the WRB layer is substantially bulk water resistant and substantially water vapor permeable.

8. The IWS panel as recited in claim 1, wherein the extension flap is continuous or discontinuous along a length of the edge from which it exceeds beyond the panel.

9. The IWS panel as recited in claim 1, wherein the extension flap, in a direction perpendicular to the edge of the lignocellulosic panel, is 0.1% to 50% of the shortest and the longest dimension of the lignocellulosic panel, respectively.

10. The IWS panel as recited in claim 9, wherein the extension flap in its direction parallel to the edge of the lignocellulosic panel, is from 0% to 20% the length of the edge of the panel.

11. The IWS panel as recited in claim 10, wherein, the release liner covers the surface area of the extension flap of the barrier layer from about 10% to 100%.

12. The IWS panel as recited in claim 1, wherein the first insulation layer is foam insulation comprising polyisocyanurate foam, polystyrene foam, polyurethane foam, EPS, GPS, XPS, or a combination thereof.

13. The IWS panel as recited in claim 1, wherein the first insulation layer has a density in the range of about 1 to about 20 pounds per cubic feet (pcf) according to ASTM D1622.

14. The IWS panel as recited in claim 13, wherein the first insulation layer has a water absorption of less than about 10% according to ASTM C209 or ASTM C2842.

15. The IWS panel as recited in claim 14, wherein the first insulation layer has a water vapor permeance from about 0.1 to about 20 perms as determined according to ASTM E96.

16. The IWS panel as recited in claim 1, wherein the system exhibits a thermal resistance value (R-value) from about 1 to about 15 according to ASTM C1289-02.

17. The IWS panel as recited in claim 1, wherein the first open-celled insulation layer further comprises a membrane layer.

18. The IWS panel as recited in claim 17, wherein the insulation membrane layer comprises radiant barrier material, polymeric film, polymeric fabric, paper, cellulosic material, reinforcing scrim, or a combination thereof.

19. The IWS panel as recited in claim 1, wherein the first insulation layer is secured to the panel using an adhesive selected from a phenol-formaldehyde resin, hot-melt adhesive, polyvinyl acetate (PVA) resin, or a combination thereof.

20. The IWS panel as recited in claim 1, wherein the WRB barrier layer comprises a resin-impregnated paper substantially covering the outward facing surface of the panel, the resin-impregnated paper having a paper basis weight of 21.772 kg (48 lbs.) to about 102.058 kg (225 lbs.) per ream and a resin content of less than 80% by dry weight.

21. The IWS panel as recited in claim 20, wherein each panel and barrier layer has a water vapor transmission rate from about 0.7 to about 7 grams/m²/24 hrs as determined according to ASTM E96 procedure A (at 73° F.-50% RH) and a liquid water transmission rate from about 1 to about 28 grams/100 in²/24 hrs via Cobb ring according to ASTM D5795.

22. The IWS panel as recited in claim 21, wherein an outer surface of the barrier layer is textured.

23. The IWS panel as recited in claim 22, wherein the textured outer surface provides a wet coefficient of friction in a range of about 0.8 to about 1.1 (English XL Tribometer) and a dry coefficient of friction of at least about 0.8 (English XL Tribometer).

24. The IWS panel as recited in claim 1, wherein each panel comprises an oriented strand board, a plywood, a particleboard, a chipboard, a medium-density fiberboard, or a waferboard.

25. The IWS panel as recited in claim 1, wherein the structurally stable panel comprises other plant-based materials, said other plant-based materials are described as below:
grass, including perennial grass, switchgrass such as Panicum virgatum L, Miscanthus, Sorghum, sugarcane, millets, Napier grass, giant reed, and other forage and turf grasses, subalpine grasses, native grass, sedge, rush include Agrostis exarata (Spike Bentgrass), Ammophila arenaria (European sand dune or beach grass), Ammophila breviligulata (American beach grass), Ammophila champlainensis Seymour, Ammophila maritima, Beckmannia zyzigachne (American Sloughgrass), Bromus carinatus (California Brome), Bromus vulgaris (Columbia Brome), Carex densa (Dense-Headed Sedge), Carex feta (Green-Sheathed Sedge), Carex leporina (Harefoot Sedge), Carex lenticularis (=C. kelloggii) (Shore Sedge), Carex lyngbyel (Lyngby Sedge), Carex macrocephala (Big Headed Sedge), Carex obmupta (Slough Sedge), Carex pansa (Foredune Sedge), Carex unilateralis (One-Sided Sedge), Deschampsia caespitosa (Tufted Hair Grass), Eleocharis palustis (Creeping Spike rush), Elymus glaucus (Blue Wild Rye), Festuca idahoensis var. roemeri (Roemer's Fescue), Festuca rubra var. littoralis (Shore Fescue), Festuca subulata (Bearded Fescue), Glyceria elata (Tall Mannagrass), Glyceriaoccidentalis (Western Mannagrass), Hordeum brachyantherum (Meadow Barley), Juncus effusus (Soft Rush), Juncus patens (Spreading Rush), Juncus temiis (Slender Rush), Lozula campestris (Woodrush), Phalaris arundinacea (Reed Canary Grass), Phalaris aquatica, Phalaris tuberosa (Staggers Grass), Phalaris canariensis, Poa Macrantha (Dune Bluegrass), ReGreen (Sterile Hybrid Wheat), Scirpus acutus (Hardstem Bullrush), Scirpus americanus, Scirpus cyperimis, Scirpus maritimus (Seacoast Bullrush), Scirpus microcarpus, Scirpus validus, Sparagamim eurycarpum (Giant Burreed), Triglochin maritinum (Seaside Arrowgrass), Typha latifolia (Cattail), Alopecuris geniculatus, Carex pachystachya, Carex stipata (grass like), Danthonia californica, Eleocharis ovata (grass like), Glycaria grandis, Juncus acuminatus, Juncus bolanderi and Juncus ensifolius (Daggar leaf rush). By way of example, other grasses include the Lily of the Nile (Agapanthus africanus), white fountain grass (Pennisetum ruppellii), muhly grass (Muhlenbergia capillaris), African iris (Dietes vegeta), podocarpus (Podocarpus macrophyllus), wax myrtle (Myrica cerifera), Aztec grass (Ophiopogon intermedius argenteomarginatus), mondo grass (Ophiopogon japonicus), evergreen giant (Liriope muscan), evergreen Paspalum (Paspalum quadrifarium) and sand cord grass (Spartina bakerii).

26. The panel as recited in claim 3, wherein the structurally stable panel comprises other plant-based materials, said other plant-based materials comprising flax fibers and flax shives produced from processing waste flax straw.

27. The panel as recited in claim 26, wherein the lignocellulosic component in the wood-composite panel includes more than one of the plant-based materials, wherein the wood composite panel comprises a binder material and other plant-based material, wherein said panel includes at least 70 percent other plant-based material by weight and at least 2.5 percent thermoplastic binder by weight.

28. (canceled)

29. The IWS panel as recited in claim 27, wherein said thermoplastic binder material comprises one or more selected from the group consisting of: high density polyethylene, recycled high-density polyethylene, or a combination thereof.

30. (canceled)

31. The IWS panel as recited in 27, wherein said binder material is a formaldehyde-free binder, contains zero volatile organic compounds (VOC), or a combination thereof.

32. (canceled)

33. The IWS panel as recited in claim 31, wherein said binder material comprises polymeric methylene diphenyl diisocyanate (PMDI).

34. The IWS panel as recited in claim 33, wherein said binder material comprises a protein-based resin, wherein said protein-based resin is selected from the group of protein-based resins consisting of a soy protein-based resin, a canola protein-based resin, a castor protein-based resin, jatropha protein-based resin and combinations thereof.

35. (canceled)

36. The IWS panel as recited in claim 27, wherein said panel includes 80 to 90 percent other plant-based material portions by weight, 8 to 12 percent recycled high density polyethylene and 3 to 5 percent polymeric methylene diphenyl diisocyanate (PMDI) by weight.

37. The IWS panel as recited in claim 1, wherein said panel comprises at least two oriented strand layers, each oriented strand layer containing a binder material and other plant-based material portions, each oriented strand layer having a layer axis with greater than 90% of said other plant-based material portions aligned within +/−45 degrees of said layer axis, and wherein at least one oriented strand layer has a layer axis oriented at a non-zero angle relative to a layer axis of another oriented strand layer.

38. The IWS panel as recited in claim 1, wherein said structurally stable panel is selected from the group of wood composite panel types consisting of oriented strand wood composite panel, fiber wood composite panel, particle wood composite panel and layer comprising other plant-based material.

39. The IWS panel as recited in claim 1, wherein said panel has a density in the range of 42 to 54 lbs/ft³.

40. The IWS panel or panel assembly as recited in claim 1, wherein the open-celled foam layer comprises a sprayable foam that is made from polyurethane sprayable foams, polyurea sprayable foams, and combinations thereof.

41. The IWS panel or panel assembly as recited in claim 40, wherein the sprayable foam is selected from the group consisting of acrylic foams, latex foams, melamine foams, isocyanurate foams, and silicone foams.

42. The IWS panel or panel assembly as recited in claim 40, wherein the open-celled polyurethane with the open cell structure has a density of between 0.60 and 1.5 lb. per cubic foot, or the density of the open cell polyurethane foam is between 0.90 and 1.20 lb. per cubic foot, or the density of the foamed open cell polyurethane foam is between 1.00 and 1.15 lb. per cubic foot; and/or
wherein the open cell content of the foams of the first open-celled foam insulation layer is greater than 85%, or 90%, or 95%, or 98%.

43. (canceled)

44. The IWS panel or panel assembly as recited in claim 42, comprising a blowing agent, wherein the blowing agent comprises water, carbon dioxide, hydrofluorocarbons (HFCs), chlorinated fluorocarbons, or hydrofluoro olefins (HFOs).

45. A panel assembly comprising at least two panels juxtaposed and/or adhered to each other, wherein at least one panel is according to the IWS panel, as recited in claim 1.

46. A method of manufacturing an IWS panel or an IWS panel system, wherein the wood composite panel is made by a method comprising the steps of:
combining a binder material and other plant-based material portions to produce a combined material, wherein said combined material includes at least 70 percent other plant-based material portions by weight and at least 2.5 percent thermoplastic binder by weight; and
heating and pressing said combined material.

47. The method as recited in claim 46, wherein the heating and pressing step is accomplished in a press at a temperature in the range of 125 to 400 degrees Fahrenheit, at a pressure in the range of 100 to 300 psi, or a combination thereof.

48. (canceled)

49. The method as recited in claim 46, wherein said other plant-based material portions have a moisture content in the range of about 1.0 to 5.0 percent when combined with the binder.

50. The method as recited in claim 49, further comprising the steps of:
harvesting other plant materials by mowing other plant-based materials:
conditioning each mowed stalk at the harvest site by crimping the mowed stalk at a plurality of locations to increase other plant-based material drying;
refining other plant-based material into fibers using a mill; and
screening the fibers to remove other plant-based material fines.

51. A wood composite panel made by a process comprising the steps of:
combining a binder material and other plant-based material portions to produce a combined material, wherein said combined material includes at least 70 percent other plant-based material portions by weight and at least 2.5 percent thermoplastic binder by weight; and
heating and pressing said combined material.
